(19) United States
(12) Patent Application Publication
(10) Pub. No.: US 2014/0377596 A1
(43) Pub. Date: Dec. 25, 2014

(54) HYBRID BATTERY SYSTEM FOR ELECTRIC AND HYBRID ELECTRIC VEHICLES

(71) Applicant: Energy Power Systems, LLC, Troy, MI (US)

(72) Inventors: Subhash K. DHAR, Bloomfield Hills, MI (US); Dennis TOWNSEND, Stevenson, MD (US); Fabio ALBANO, Royal Oak, MI (US); Srinivasan VENKATESAN, Bloomfield Hills, MI (US); William KOETTING, Davisburg, MI (US); Franklin MARTIN, Rochester, MI (US); Lin HIGLEY, Troy, MI (US)

(73) Assignee: Energy Power Systems, LLC

(21) Appl. No.: 14/482,323

(22) Filed: Sep. 10, 2014

Related U.S. Application Data
(63) Continuation-in-part of application No. 13/475,484, filed on May 18, 2012.
Application No. 13/475,484 is a continuation-in-part of application No. 13/419,678, filed on Mar. 14, 2012.

(51) Int. Cl. H01M 16/00; B60R 16/04

(52) U.S. Cl. CPC H01M 16/00; B60R 16/04; Y10S 903/907
USPC 429/9; 180/65.21; 903/907

(57) ABSTRACT

An electrochemical energy storage system is provided for an application having design energy and power requirements. The electrochemical energy storage system comprises first and second energy storage system components having different electro-chemistries and formed in different units. Said first energy storage system component includes a non-lead-acid battery adapted to provide the energy requirements of the application. Said second energy storage system component includes a lead-acid battery adapted to provide the power requirements of the application. Said first and second energy storage system components have a combined capacity that is less than a capacity of a mono-electrochemical energy storage system adapted to supply both the power and energy requirements of the application.

### RELATED APPLICATIONS

This application is a continuation in part of U.S. application Ser. No. 13/475,484, filed May 18, 2012, and a continuation in part of U.S. application Ser. No. 13/419,678 filed Mar. 14, 2012, which incorporates by reference the entire disclosure of U.S. application Ser. No. 13/350,505, filed Jan. 13, 2012, and the entire disclosure of U.S. application Ser. No. 13/350,686, filed Jan. 13, 2012. The entire content of the above applications is incorporated by reference in this application.

### TECHNICAL FIELD

Embodiments of the present disclosure relate generally to battery systems, preferably for use in electric and hybrid electric vehicles. More particularly, embodiments of the present disclosure relate to hybrid-battery systems, having two or more electro-chemistries, preferably incorporating one or more lead-acid batteries.

### BACKGROUND

Lead-acid electrochemical cells have been commercially successful as power cells for over one hundred years. For example, lead-acid batteries are widely used for starting, lighting, and ignition (SLI) applications in the automotive industry.

As an alternative to lead-acid batteries, nickel-metal hydride (“Ni-MH”) and lithium-ion (“Li-ion”) batteries have been used for electric and hybrid electric vehicle applications. Despite their higher cost, Ni-MH and Li-ion electro-chemistries have been favored over lead-acid electrochemistry for hybrid and electric vehicle applications due to their higher specific energy and energy density compared to lead-acid batteries.

While lead-acid, Ni-MH, and Li-ion batteries have each experienced commercial success, conventionally, each of these three types of electro-chemistries has been limited to certain applications. FIG. 7 shows a Ragone plot of various types of electrochemical cells that have been used in automotive applications, depicting their respective specific powers and specific energies compared to other technologies.

Lead-acid battery technology is low-cost, reliable, and relatively safe. Certain applications, such as complete or partial electrification of vehicles and back-up power applications, require higher specific energy than traditional SLI lead-acid batteries deliver. As shown in Table 1, conventional lead-acid batteries suffer from low specific energy due to the weight of the components. Thus, there remains a need for low-cost, reliable, and relatively safe electrochemical cells for various applications that require high specific energy and high specific power, including certain automotive and back-up power applications.

Lead-acid batteries have many advantages. First, they are low-cost and are capable of being manufactured anywhere in the world. Production of lead-acid batteries can be readily scaled-up. Lead-acid batteries are available in large quantities in a variety of sizes and designs. In addition, they deliver good high-rate performance and moderately good low- and high-temperature performance. Lead-acid batteries are electrically efficient, with a turnaround efficiency of 75 to 80%, provide good “float” service (where the charge is maintained near the full-charge level by trickle-charging), and exhibit good charge retention. Further, although lead is toxic, lead-acid battery components are easily recycled. An extremely high percentage of lead-acid battery components (in excess of 95%) are typically recycled.

Lead-acid batteries also suffer from certain disadvantages. They have relatively low cycle-life, particularly in deep-discharge applications. Due to the weight of the lead components and other structural components needed to reinforce the plates, lead-acid batteries typically have limited energy density. If lead-acid batteries are stored for prolonged periods in a discharged condition, sulfation of the electrodes can occur, damaging the battery and impairing its performance. In addition, hydrogen can be evolved in some designs.

In contrast to lead-acid batteries, Ni-MH batteries use a metal hydride as the active negative material along with a conventional positive electrode such as nickel hydroxide. Ni-MH batteries feature relatively long cycle life, especially at a relatively low depth of discharge. The specific energy and energy density of Ni-MH batteries are higher than for lead-acid batteries. In addition, Ni-MH batteries are manufactured in small prismatic and cylindrical cells for a variety of applications and have been employed extensively in hybrid electric vehicles. Larger size Ni-MH cells have found limited use in electric vehicles.

The primary disadvantage of Ni-MH electrochemical cells is their high cost. Li-ion batteries share this disadvantage. Yet, improvements in energy density and specific energy of Li-ion designs have outpaced comparable advances in Ni-MH designs in recent years. Thus, although Ni-MH batteries currently deliver substantially more power than designs of a decade ago, the progress of Li-ion batteries, in addition to their inherently higher operating voltage, has made them technically more competitive for many hybrid applications that would otherwise have employed Ni-MH batteries.

Li-ion batteries have captured a substantial share not only of the secondary consumer battery market but a major share of OEM hybrid battery, vehicle, and electric vehicle applications as well. Li-ion batteries provide high-energy density and high specific energy, as well as long cycle life. For example, Li-ion batteries can deliver greater than 1,000 cycles at 80% depth of discharge.

Li-ion batteries have certain advantages. They are available in a wide variety of shapes and sizes, and are much lighter than other secondary batteries that have a comparable energy capacity (both specific energy and energy density). In addition, they have higher open circuit voltage (typically ˜3.5 V vs. 2 V for lead-acid cells). In contrast to Ni—Cd and, to a lesser extent, Ni-MH batteries, Li-ion batteries suffer no “memory effect,” and have much lower rates of self discharge (approximately 5% per month) compared to Ni-MH batteries (up to 20% per month).

Li-ion batteries, however, have certain disadvantages. They are expensive. Rates of charge and discharge above 1C at lower temperatures are challenging because lithium diffusion is slow and it does not allow for the ions to move fast enough. Using liquid electrolytes to allow for faster diffusion rates, result in formation of dendritic deposits at the negative electrode, causing hard shorts and resulting in potentially dangerous conditions. Liquid electrolytes also form deposits (referred to as an SEI layer) at the electrolyte/electrode interface, that can inhibit electron transfer, indirectly causing the cell's rate capability and capacity to diminish over time. These problems can be exacerbated by high-charging levels and elevated temperatures. Li-ion cells may irreversibly lose capacity if operated in a float condition.

At rates substantially in excess of IC, substantial heat is generated. Poor cooling and increased internal resistance cause temperatures to increase inside the cell, further degrading battery life. Most important, however, Li-ion batteries may suffer thermal runaway, if overheated, overcharged, or over-discharged. This can lead to cell rupture, exposing the active material to the atmosphere. In extreme cases, this can cause the battery to catch fire. Deep discharge may short-circuit the Li-ion cell, causing recharging to be unsafe.

To manage these risks, Li-ion batteries are typically manufactured with expensive and complex power and thermal management systems. In a typical Li-ion application for a hybrid vehicle, two-thirds of the volume of the battery module may be given over to collateral equipment for thermal management and power electronics and battery management, dramatically increasing the overall size and weight of the battery system, as well as its complexity and cost.

In addition to the differing advantages and disadvantages of lead-acid, Ni-MH and Li-ion batteries, the specific energy, energy density, and specific power of these three electro-chemistries vary substantially. Typical values for systems used in HEV-type applications are provided in Table 1 below.

TABLE 1

| | Specific | | |
|---|---|---|---|
| | Energy | Volumetric | |
| Electro-chemistry | Density | Energy | Specific Power |
| Type | (Whr/kg) | Density (Whr/l) | Density (W/kg) |
| Lead-Acid¹ | 30-50 | 60-75 | 100-250 W/kg |
| | Whr/kg | Whr/l | |
| Nickel Metal | 65-100 | 150-250 | 250-550 W/kg |
| Hydride (Ni—MH)² | Whr/kg | Whr/l | |
| Lithium-Ion (Li- | up to 131 | 250 Whr/l | up to 2,400 W/kg |
| ion)³ | Whr/kg | | |

¹http://en.wikipedia.org/wiki/Lead_acid_battery, accessed Jan. 11, 2012.
²Linden, David, ed., Handbook of Batteries, 3^{rd} Ed. (2002).
³http://info.a123systems.com/data-sheet-20ah-prismatic-pouch-cell, accessed Jan. 11, 2012.

Although both Ni-MH and Li-ion battery chemistries have claimed a substantial role in electric and hybrid electric vehicles, both electro-chemistries are substantially more expensive than lead-acid batteries for vehicular propulsion assist. The present inventors believe that the embodiments of the present disclosure can substantially improve the capacity of lead-acid batteries to provide a viable, low-cost alternative to Ni-MH and Li-ion electro-chemistries in all types of electric, and hybrid electric vehicle applications.

In particular, certain applications have proved difficult for Ni-MH and Li-ion batteries, including certain automotive and standby power applications. Standby power application requirements have gradually been raised. The standby batteries of today have to be truly maintenance free, have to be low-cost, have long cycle-life, have low self-discharge, be capable of operating at extreme temperatures, and, finally, should have high specific energy and high specific power. Emerging smart grid applications to improve energy efficiency require high power, long life, and lower cost for continued growth in the market place.

Automobile manufacturers have encountered substantial consumer resistance in launching fleets of electric and hybrid-electric vehicles, due to the increased cost of these vehicles relative to conventional automobiles powered by an internal combustion engine (“ICE”). Environmental and energy independence concerns have exerted greater pressures on manufacturers to offer cost-effective alternatives to internal combustion engine-powered vehicles. Although hybrids and electric vehicles can meet this demand, they typically rely on subsidies to defray the higher cost of the energy storage systems.

The definitions of various types of electric and hybrid-electric vehicles are not standardized. Among the more significant market segments that are generally recognized are “stop-start” micro-hybrid electric vehicles, mild-hybrid electric vehicles, strong-hybrid electric vehicles, and plug-in hybrid electric vehicles. Table 2 below compares the application of various battery electro-chemistries and the internal combustion engine (ICE) and their current roles in certain automotive applications. As used in Table 2, “SLI” means starting, lighting, ignition; “HEV” means hybrid electric vehicle; “PHEV” means plug-in hybrid electric vehicle; “EREV” means extended range electric vehicle; and “EV” means electric vehicle.

TABLE 2

| | | Start/ | Power | | Mild | | | | |
|---|---|---|---|---|---|---|---|---|---|
| | SLI | Stop | Assist | Regeneration | Hybrid | HEV | PHEV | EREV | EV |
| Pb-Acid | ✓ | | | | | | | | |
| Ni-MH | | | ✓ | ✓ | ✓ | ✓ | | | |
| Li-ion | | | ✓ | ✓ | ✓ | ✓ | ✓ | ✓ | ✓ |
| ICE | ✓ | ✓ | ✓ | ✓ | ✓ | ✓ | ✓ | ✓ | |

As shown in Table 2, there remains a need for specific applications in which partial electrification of the vehicle may provide environmental and energy efficiency advantages, without the same level of added costs and risks associated with electric and hybrid-electric vehicles using Ni-MH and Li-ion batteries. Even more specifically, there is a need for a low cost, energy efficient battery in the area of start/stop automotive applications.

This is because specific points in the duty cycle of an internal combustion engine entail far greater inefficiency than others. Internal combustion engines operate efficiently only over a relatively narrow range of crankshaft speeds. For example, when the vehicle is idling at a stop, fuel is being consumed with no useful work being done. Idle vehicle running time, stop/start events, rapid acceleration, and power steering, air conditioning, or other power electronics component operations, entail substantial inefficiencies in terms of fuel economy. In addition, environmental pollution from a vehicle at these idle, stop/start, and rapid acceleration conditions is far worse than from a running vehicle that is moving at an efficient speed. The partial electrification of the vehicle in relation to these more extreme operating conditions has been termed a “micro-” or “mild-” hybrid application, including stop/start electrification. Micro- and mild-hybrid technologies are unable to displace as much of the power delivered by the internal combustion engine as a full hybrid or electric vehicle. Nonetheless, they may be able to substantially increase fuel efficiency in a cost-effective manner without the substantial capital expenditure associated with full hybrid or full electric vehicle applications.

Conventional lead-acid batteries have not yet been able to fulfill this role. Conventional lead-acid batteries have been designed and optimized for the SLI application. The needs of a mild-hybrid application are different. A new process, design, and production process need to be developed and optimized for the mild-hybrid application.

One need for a mild-hybrid application is low-weight battery. Conventional lead-acid batteries are relatively heavy. This causes the battery to have a low specific energy. SLI lead-acid batteries typically have thinner plates, providing increased surface area needed to produce the power necessary to start the engine. But the grid thickness is limited to a minimum useful thickness because of the casting process and the mechanics of the grid hang. The minimum grid thickness is also determined on the positive electrode by corrosion processes. Positive plates are rarely less than 0.08″ (main outside framing wires) and 0.05″ on the face wires because of the difficulties of casting at production rates and, more importantly, concern over poor cycle-life. These parameters limit power. Lead-acid batteries designed for deeper discharge applications (such as motive power for forklifts) typically have heavier plates to enable them to withstand the deeper depth of discharge in these applications, reducing specific energy.

Another need for a mild-hybrid application is that rechargeable batteries should be able to be charged and discharged with less than 0.001% energy loss at each cycle. This is a function of the internal resistance of the design and the overvoltage necessary to overcome it. The reaction should be energy-efficient and should involve minimal physical changes to the battery that might limit cycle life. Side chemical reactions that may deteriorate the cell components, cause loss of life, create gaseous byproducts, or loss of energy should be minimal or absent. In addition, a rechargeable battery should desirably have high specific energy, low resistance, and good performance over a wide range of temperatures and be able to mitigate the structural stresses caused by lattice expansion. When the design is optimized for minimum resistance, the charge and discharge efficiency dramatically improve.

Lead-acid batteries have many of these characteristics. The charge-discharge process is highly-reversible. The lead-acid system has been extensively studied and the secondary chemical reactions have been identified. And their detrimental effects have been mitigated using catalyst materials or engineering approaches. Although its energy density and specific energy are relatively low, the lead-acid battery performs reliably over a wide range of temperatures, with good performance and good cycle life. A primary advantage of lead-acid batteries remains their low-cost.

A number of trade-offs must be considered in optimizing lead-acid batteries for various standby power and transportation uses. High-power density requires that the initial resistance of the battery be minimal High-power and energy densities also require the plates and separators be porous and, typically, that the paste density also be very low. High cycle-life, in contrast, requires premium separators, high paste density, and the presence of binders, modest depth of discharge, good maintenance, and the presence of alloying elements and thick positive plates. Low-cost, in further contrast, requires both minimum fixed and variable costs, high-speed automated processing, and that no premium materials be used for the grid, paste, separator, or other cell and battery components.

The present inventors have found that, despite improvements in lead-acid electrochemical cells for automotive applications, prior known lead-acid batteries have not been able to achieve the same performance as Li-ion or Ni-MH cells for similar applications. There remains a need, therefore, for further improvements in the design and composition of lead-acid electrochemical cells to meet the specialized needs of the automotive and standby power markets. Specifically, there remains a need for a reliable replacement for lithium-ion electrochemical cells in certain applications that do not entail the same safety concerns raised by Li-ion electrochemical cells. Similarly, there remains a need for a reliable replacement for Ni-MH and Li-ion electrochemical cells with the added benefits of low-cost and reliability of lead-acid electrochemical cells. In addition, there remains a need for substantial improvement in battery production capacity to meet the growing needs of the automotive and standby power markets.

The United States Department of Energy (USDOE) has issued Corporate Average Fuel Efficiency (CAFE) guidelines for automotive fleets. Previously, SUVs and light trucks were excluded from the CAFE averages for motor vehicles. More recently, however, integrated guidelines have emerged specifying fuel efficiency standards for passenger vehicles, light trucks, and SUVs. These guidelines require an average fuel efficiency of 31.4 miles per gallon by 2016. http://www.epa.gov/oms/climate/regulations/420r10009.pdf.

Anticipated improvements in internal combustion engine technology do not appear to be able to reach this goal. Similarly, the manufacturing capacity for pure hybrids and pure electric vehicles does not appear sufficient to be able to reach this goal. Thus, it is anticipated that some combination of micro-hybrids or mild-hybrids, in which electrochemical cells provide some of the power for either stop/start or certain acceleration applications, will be necessary in order to meet the CAFE standards.

Lead-acid battery systems may provide a reliable replacement for Li-ion or Ni-MH batteries in these applications, without the substantial safety concerns associated with Li-ion electrochemistry and the increased cost associated with both Li-ion and Ni-MH batteries.

Electric vehicles were in widespread use in the early 20th century (1900 to 1912). During this period over 30,000 electric vehicles were introduced into the United States. The dangers of hand-cranking early automobiles made early electric-drive vehicles attractive. The development of the electric starter motor, however, eliminated the dangers of hand-cranking and enabled the gas-powered internal combustion engine to prevail over electric-drive designs. The high cost of batteries relative to internal combustion engine technologies effectively precluded the development of electric and hybrid-electric vehicles during most of the balance of the 20th century.

In response to increasing fuel efficiency and environmental concerns, electric and hybrid-electric vehicles were reintroduced into the American market in the 1990s. Most of these were powered by Ni-MH batteries, although lead-acid batteries and other advanced battery designs were also used. These Ni-MH batteries, however, suffered several disadvantages including limited range, slow charging, and high cost. Throughout the development of electric and hybrid electric vehicles in the 20th and 21st Centuries, the high cost of the batteries has frustrated commercialization.

Most electric vehicles that have been introduced into the US market currently employ Li-ion batteries, including those made by BMW; BYD; Daimler Benz; Ford; Mitsubishi; Nissan; REVA; Tesla; and Think. Of the major developers of 21st Century electric vehicles, only Chrysler and REVA have employed lead-acid battery technology. Both, however, were making small, lightweight, specialized hybrid vehicles and not a full-sized hybrid passenger sedan. Moreover, Chrysler recently sold its GEM unit.

The design of batteries for electric and hybrid-electric vehicles typically involves a trade-off between energy and power. As the capability to provide power over time, specific energy is typically measured in Watt-hours (Wh/kg) per kilogram. Specific power is typically measured in Watts per kilogram (W/kg).

The power and energy requirements for a typical stop/start hybrid electric vehicle application are generally no more challenging than for a conventional SLI application. The specific power requirements can be in the range of 600 Watts per kilogram and the specific energy requirements in the range of 25 Watt-hours per kilogram. These limits can be met with conventional lead-acid battery technology. Nonetheless, use of conventional lead-acid battery technology to satisfy these requirements typically results in systems that have excessive weight. Moreover, systems for stop-start hybrid electric vehicles may be required to perform several hundred thousand cycles and deliver several megawatt hours of total energy. These requirements are difficult for conventional lead-acid batteries to achieve in practice. Thus, although the specific power and specific energy requirements of stop-start hybrid electrical vehicles are within the theoretical range of conventional lead-acid battery technology, practical requirements have precluded their use in this application. Instead, Li-ion batteries are typically required to meet these requirements. Reddy, Thomas D., ed., LINDEN'S HANDBOOK OF BATTERIES (4^{th} ed.), at 29-30, McGraw-Hill, New York, N.Y. (2011).

### SUMMARY

According to an embodiment of the disclosure, an electrochemical energy storage system is provided for an application having design energy and power requirements. The electrochemical energy storage system comprises first and second energy storage system components having different electro-chemistries and formed in different units. Said first energy storage system component includes a non-lead-acid battery adapted to provide the energy requirements of the application. Said second energy storage system component includes a lead-acid battery adapted to provide the power requirements of the application. Said first and second energy storage system components have a combined capacity that is less than a capacity of a mono-electrochemical energy storage system adapted to supply both the power and energy requirements of the application. The lead-acid battery has a specific power that is greater than or equal to about 650 Watts/kilogram and less than or equal to about 1,900 Watts/kilogram. The lead-acid battery has a specific energy that is greater than or equal to about 25 Watt-hours/kilogram and less than or equal to about 80 Watt-hours/kilogram.

According to another embodiment, a battery system for an application having design energy and power requirements is provided. The battery system comprises first and second energy storage system components having different electro chemistries and formed in different units. Said first energy storage system component includes a non-lead-acid battery adapted to provide the energy requirements of the application. Said second energy storage system component includes a lead-acid battery adapted to provide the power requirements of the application. Said first and second energy storage system components have a combined capacity that is less than a capacity of a single chemistry energy storage system adapted to supply both the power and energy design requirements of the application. The lead-acid battery has a specific power that is greater than or equal to about 650 Watts/kilogram and less than or equal to about 1,900 Watts/kilogram. The lead-acid battery has a specific energy that is greater than or equal to about 25 Watt-hours/kilogram and less than or equal to about 80 Watt-hours/kilogram.

According to another embodiment, a vehicle having design energy and power requirements is provided. The vehicle comprises a motor for driving the vehicle according to the energy and power requirements and first and second energy storage system components electrically coupled to the motor. The first and second energy storage system components include different electro chemistries and are formed in different units. Said first energy storage system component includes a non-lead-acid battery adapted to provide the energy requirements of the vehicle. Said second energy storage system component includes a lead-acid battery adapted to provide the power requirements of the vehicle. Said first and second energy storage system components have a combined capacity that is less than a capacity of a mono-electrochemistry battery pack adapted to supply both the power and energy requirements of the vehicle. The lead-acid battery has a specific power that is greater than or equal to about 650 Watts/kilogram and less than or equal to about 1,900 Watts/kilogram. The lead-acid battery has a specific energy that is greater than or equal to about 25 Watt-hours/kilogram and less than or equal to about 80 Watt-hours/kilogram.

Additional objects and advantages of the disclosure will be set forth in part in the description which follows, and in part will be apparent from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiments of the disclosure and together with the description, serve to explain the principles of the disclosure.

### BRIEF DESCRIPTION OF THE DRAWINGS

FIG. 1 is a schematic diagram of a series hybrid electric vehicle power train.

FIG. 2 is a schematic diagram of a hybrid-battery system of an embodiment of the present disclosure for a series hybrid electric vehicle.

FIGS. 3A and 3B are graphical representations of the displacement of a portion of a Li-ion hybrid electric vehicle battery system that may be achieved by reducing the size of the Li-ion component adapted to provide high energy and combining it with a second battery component adapted to provide high power of the present disclosure.

FIG. 4 is schematic diagram of an alternative hybrid drive system.

FIG. 5 is a schematic diagram of a hybrid-battery system adapted for the hybrid drive system of FIG. 4.

FIG. 6 is a graphical representation of the displacement of a portion of a Li-ion hybrid electric vehicle battery system in FIG. 5.

FIG. 7 shows a Ragone plot of various types of electrochemical cells.

### DETAILED DESCRIPTION

Reference will now be made in detail to exemplary embodiments of the present disclosure, examples of which are illustrated in the accompanying drawings. Wherever possible, the same reference numbers will be used throughout the drawings to refer to the same or like parts.

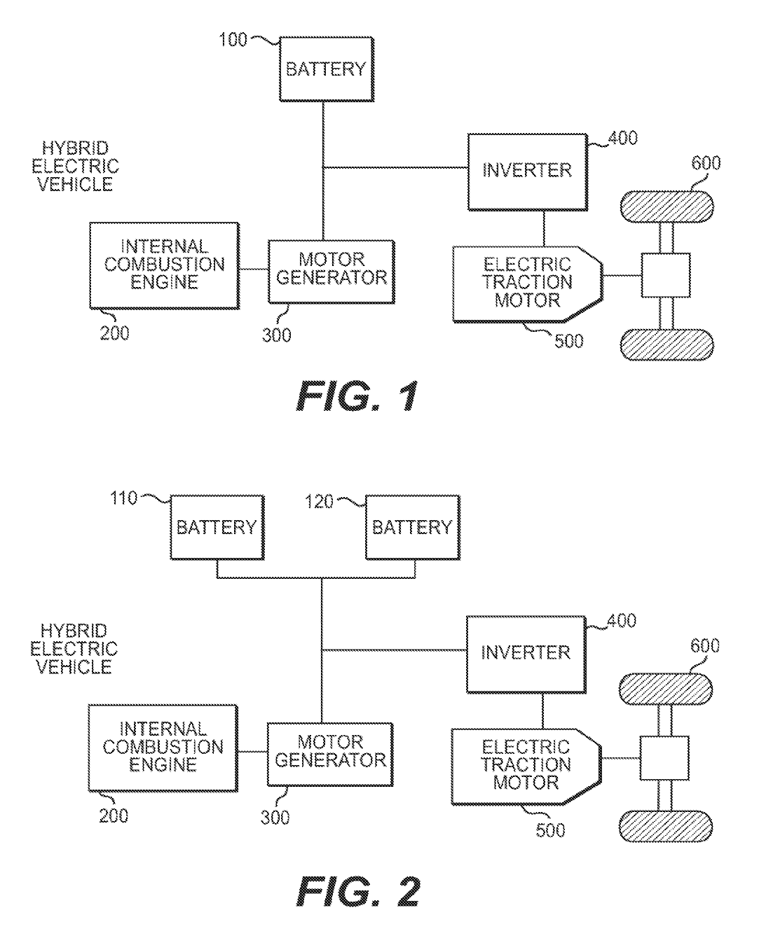

FIG. 1 depicts schematically the relationship of the principal components of a series hybrid-electric drive system. As shown in FIG. 1, Battery 100 and internal combustion engine (ICE) 200 with a motorgenerator 300 are connected in parallel to inverter 400. Inverter 400 is connected to motor/generator 500. Motor/generator 500 can either be located in the wheel hub or be connected to a transmission, which in turn drives, or is driven by the wheels 600 of the vehicle.

As depicted graphically in FIG. 2, embodiments of the present disclosure generally relate to a design of a hybrid-battery system for an electric or hybrid electric vehicle. As used herein, and as depicted graphically in FIG. 2, hybrid battery system refers to a battery system comprising two or more battery components 110 and 120. Typically some parameters involve trade-offs in battery design, such as between optimizing a battery component for high energy as opposed to high power. Preferably, each component is optimized for a different purpose, such as high energy or high power.

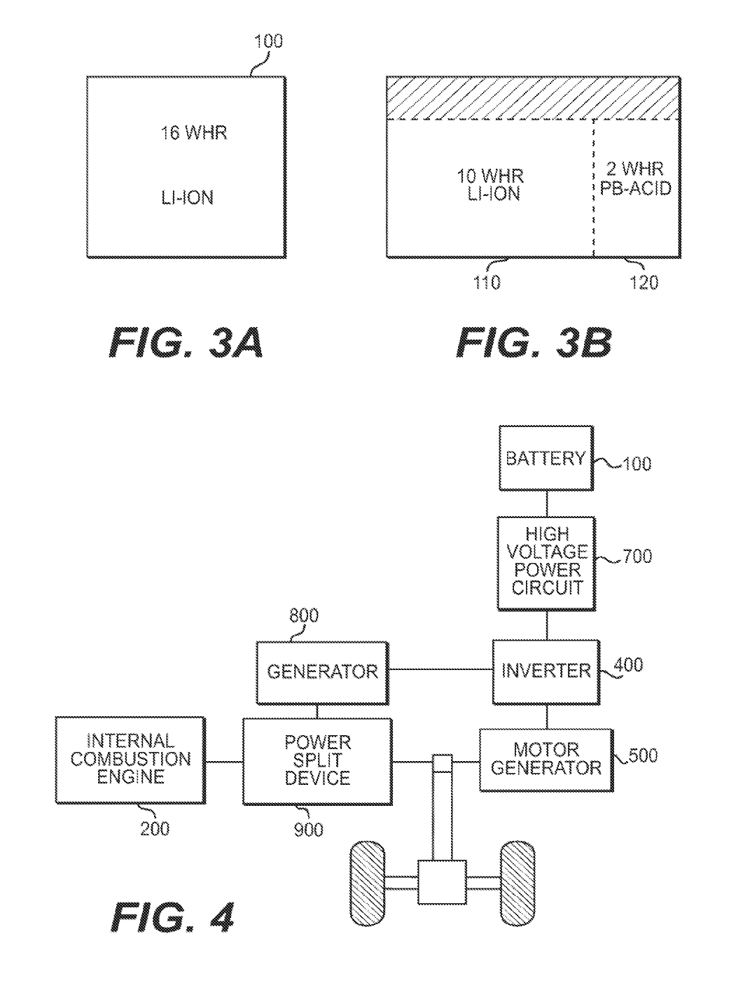

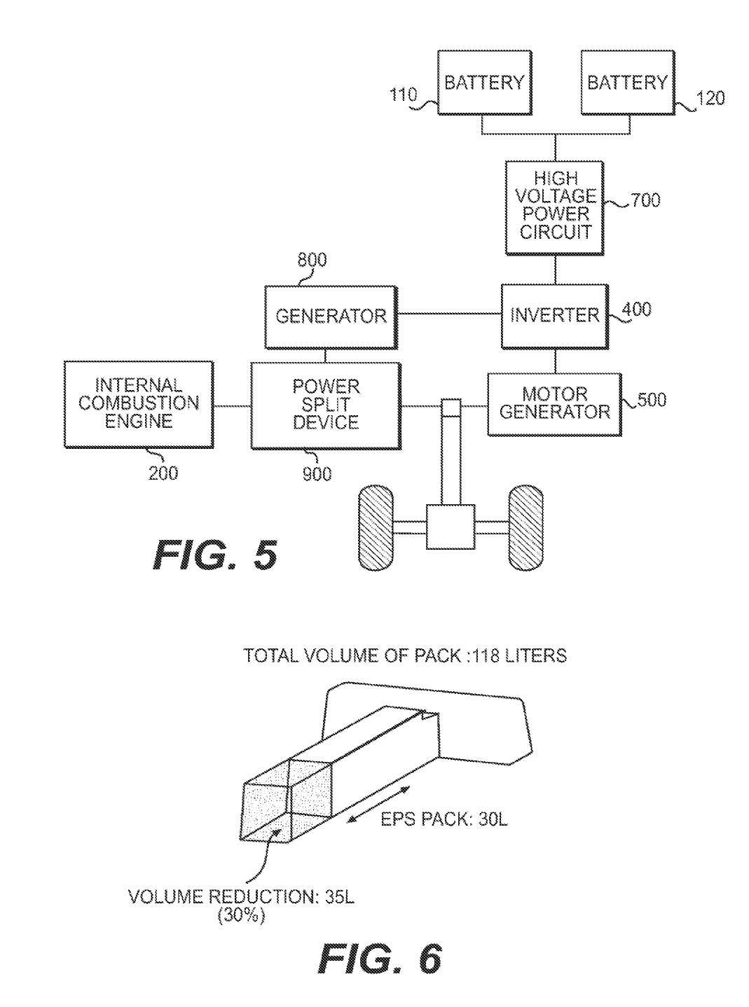

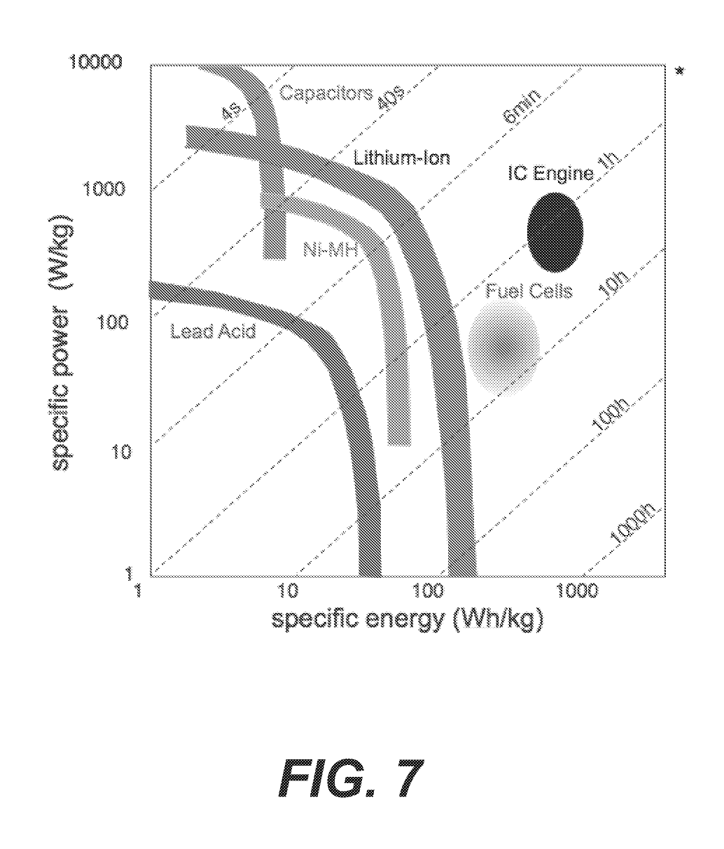

More specifically, as depicted graphically in FIGS. 3A and 3B, embodiments of the present disclosure may include improvements from combining a lead-acid battery component to supplant or supplement a portion of a different battery component, such as a Li-ion battery component. Embodiments of the present disclosure may allow for the use of lead-acid batteries in micro- and mild-hybrid applications of vehicles, either alone or in combination with Ni-MH or Li-ion batteries.

In a typical electric vehicle or hybrid electric vehicle application the primary energy storage system has a single electrochemistry and is adapted to provide both the power and energy requirements of the system. As noted above, these requirements may be antagonistic. Thus, the energy storage system is typically designed to be substantially larger than would be required by either the power or the energy requirements alone. Building a larger battery with this added capacity results in a larger, more complex battery system, and costs substantially more. For example, some hybrid vehicles employ Ni-MH batteries having about four times the capacity required to meet its power requirements. Although this excess capacity provides longer-life as well as other benefits, it substantially increases the size and cost of the battery system.

In an energy storage system that would otherwise employ a mono-electrochemistry battery, such as a Li-ion or Ni-MH battery, preferably, lead-acid batteries of the present disclosure may displace 30% to 60% of the original energy storage system capacity, while continuing to supply the design demands of the application. More preferably, lead-acid batteries may displace 35% to 55% of the original capacity. Most preferably, lead-acid batteries may displace 40% to 50% of the original capacity. The mono-electrochemical component may preferably be reduced to 70% to 40% of the original capacity. More preferably, it may be reduced to 65% to 45% of the original capacity. And, most preferably, it may be reduced to 60% to 50% of the original capacity. This preferably provides a reduction in overall capacity of the energy storage system in the range of 30% to 35%, more preferably from 25% to 30%, and most preferably from 20% to 25%.

It should be emphasized, however, that embodiments of the present disclosure are not limited to transportation and automotive applications. The cells, batteries, systems, and drive trains of the present disclosure may be employed in a wide variety of applications including, without limitation, vehicles, stationary power, charging stations, power conditioning, back-up power, and peak-power shaving applications. Embodiments of the present disclosure may be of use in any area known to those skilled in the art where use of lead-acid batteries is desired. Further, the present inventors intend that the elements or components of the various embodiments disclosed herein may be used together with other elements or components of other embodiments.

Preferably, the improved cells, batteries, and systems may be used where power requirements exceed 5 kWh/kg. Although it may be employed in any application, even applications having lower power requirements and may offer the benefits of reduced cost relative to a Li-ion or Ni-MH battery or another alternative energy storage system, the weight of the lead-acid battery component may be considered excessive at lower power levels and the combined power of the components may exceed the power of a single Li-ion or Ni-MH battery adapted for both power and energy for the same application.

Above 5 kWhr the cells, batteries, and systems of embodiments of the present disclosure are able to supplant a sufficient amount of capacity to provide substantial benefits in term of reduced, weight, volume, complexity, and cost. Thus, the cells, batteries, and system may preferably be employed in PHEV, EREV, and EV applications where the total power requirement of the combined components exceeds 5 kWhr. Although the cells, batteries, and system may also be employed in micro-hybrid or series hybrid applications, the overall benefits of the invention may not be a substantial as they are in applications presenting higher power requirements.

Preferably, the lead-acid battery component disclosed herein may also displace the SLI battery. As the lead-acid battery component has ample capacity, it may also supply the SLI needs of the vehicle. Preferably, an additional 12 Volt bus is provided to service the SLI requirements and a second bus delivering higher voltage is provided to supply traction power. Thus, it is intended that the SLI battery may be retained or may be eliminated by the lead-acid battery component that is adapted to provide the power requirements of the vehicle.

Demands for collateral power in vehicles for a various accessories is expected to increase in coming years. The cells, batteries, and systems of embodiments of the present disclosure provide substantial benefits in satisfying these increasing requirements at low cost and within the size, weight, and volume constraints on SLI batteries.

A system employing hybrid cells and batteries having different electro-chemistries requires advanced power management. Electric and hybrid-electric vehicle systems currently employ battery packs comprising multiple, and in some cases, thousands of individual cells. These systems employ power management systems that control the discharging and charging of the various cells, and battery components. These power management systems have ready application to the cells, batteries, and system of the present disclosure. Many such power management systems are well-known in the art and are in widespread use. For example Sastry, U.S. Patent Publication No. 2010/0138072 A1, for Vehicle Hybrid Energy System (filed Mar. 31, 2008), assigned to The Regents of the University of Michigan, discloses a system for the control of cells, modules, and packs with hybridized electro-chemistry. The Toyota Prius® employs another alternative power management system. The Tesla® electric vehicle employs yet another alternative power management. The precise details of the power management system are beyond the scope of the present disclosure. Nonetheless, persons of ordinary skill in the art would be able to employ any suitable known power management system in conjunction with the hybrid-battery system of the present disclosure.

For comparison purposes, certain characteristics of the hybrid battery systems of various applications are shown in Table 3.

TABLE 3
Specific Power, Specific Energy, and Estimated Cost
of Selected OEM Hybrid Battery Systems

| | | | | | | Mercedes |
|---|---|---|---|---|---|---|
| OEM | Fisker | VIA | Chevy Volt | PHEV-10/15 | PHEV-30/45 | Citaro |
| kWh | 20 | 24 | 16 | 4.4 | 13.2 | 19.4 |
| kW | 180 | 216 | 136 | 40 | 120 | 180 |
| $/kWh | $800 | $800 | $800 | $1,000 | $800 | $800 |
| Total $ | $16,000 | $19,200 | $12,800 | $4,400 | $10,560 | $15,520 |

### Example 1

### Plug-in Electric Hybrid Vehicle (10 to 15 Mile Range)

A hybrid battery system of the present disclosure may displace a portion of the Li-ion or Ni-MH battery systems in a Plug-In Electric Hybrid Vehicle having a 10 to 15 mile range (PHEV-10/15). FIG. 4 depicts schematically a drive train for a PHEV-10/15 hybrid-electric vehicle. As shown in FIG. 4, the transmission is replaced by an alternator and starter motor and pair of motor-generators (500 and 800). The two motor-generators produce a combined power of about 80 horsepower in the PHEV-10/15 version. The two-motor generators (500 and 800) are coupled with a computerized shunt system for control, a mechanical power splitter 900, and a 4.4 kWh battery pack (100). Motor-generator 1 (800) generates electrical power; Motor-generator 2 (400) drives the vehicle. Power from the ICE may (200) be split three ways: to provide torque to the wheels at constant speed; to provide additional speed to the wheels at constant torque; and to power an electric generator.

The cells, battery, and system of the present disclosure provide certain benefits in a PHEV-10/15 application, albeit not as substantial as in an application employing a larger Li-ion battery system. First, by displacing high power demands on the Li-ion battery (100), the combination of a Li-ion battery component (110) and a lead-acid battery component (120) may reduce the overall design capacity of the battery system. Specifically, rather than a 4.4 kWh Li-ion battery system, as shown in Table 1, a 2.5 kWh Li-ion coupled with a 1 kWh lead-acid battery system is capable of supplying the same amount of power under the various duty conditions encountered by the vehicle, providing comparable performance at a substantially lower cost. The hybrid system capacity is reduced from 4.4 kWh to 3.5 kWh, with commensurate savings in complexity and cost.

Further, this permits the Li-ion battery component(s) (110) to operate at a lower C-rate. The C rate is often used to describe battery loads or battery charging. The C-rate is the capacity rating (in Amp-hour) of the battery. At a C-rate of 1C the battery is discharged in an hour; at 2C, in about one-half hour; at 9C in about 6 minutes to 7 minutes, and so on. The higher the C-rate the greater the demands on the battery and corresponding greater capacity fade, increasing the temperature of the battery components, particularly for Li-ion batteries. A Plug-In Electric Hybrid (PHEV) using a Li-ion battery pack may operate at a 9C rate. By instead using a hybrid battery and reducing the C-rate of the Li-ion component, operating temperatures are reduced substantially and lifetime is increased, providing an additional margin of safety, and reduced potential toxicity of the Li-ion battery if compromised.

Further, the cost of the hybrid battery system is reduced substantially relative to the single Li-ion electrochemistry.

TABLE 4
Plug-In Hybrid Electric Vehicle PHEV 10/15

| | | | | Rated | Rated |
|---|---|---|---|---|---|
| | Cost | Component | | Energy | Power |
| | per kWh | Cost | C-Rate | kWh | kW |
| Original Li- | $1,000/kWh | $4400 | 9 C | 4.4 kWh | 40 kW |
| ion Battery | | | | | |
| Pack | | | | | |
| Modified Li- | $500/kWh | $1,250 | 2 C | 2.5 kWh | 5 kW |
| ion Battery | | | | | |
| Component | | | | | |
| Lead-Acid | $300/kWh | $300 | 35 C | 1 kWh | 35 kW |
| Battery | | | | | |
| Component | | | | | |
| Savings | | $2,850 | | 0.9 kWh | |
| | | Savings | | Reduction | |

Alternatively, a plug-in hybrid may be adapted for greater range by increasing the capacity of the battery pack. For example, a PHEV-30/45 application may deliver approximately 30 to 45 miles of all-electric drive before switching to hybrid operation. The Li-ion or NiMH battery system is substantially larger, on the order of greater than 13.2 kWhr, providing much greater potential to realize the benefits of the improved cells, battery, and system of the present disclosure.

TABLE 4
Plug-In Hybrid Electric Vehicle-PHEV (30-45 mile range)

| | | | | Rated | Rated |
|---|---|---|---|---|---|
| | Cost | Component | | Energy | Power |
| | per kWh | Cost | C-Rate | kWh | kW |
| Original Li- | $800/kWh | $10,560 | 9 C | 13.2 kWh | 120 kW |
| ion Battery | | | | | |
| Pack | | | | | |
| Modified Li- | $500/kWh | $3750 | 2 C | 7.5 kWh | 15 kW |
| ion Battery | | | | | |
| Lead-Acid | $300/kWh | $900 | 35 C | 3 kWh | 105 kW |
| Battery | | | | | |
| Savings | | $5,910 | | 2.7 kWh | |
| | | savings | | Reduction | |

### Example 2

### Extended Range Electric Vehicle—EREV

In an embodiment of the present invention, as shown in FIG. 1, a hybrid battery system may displace a portion of the Li-ion battery system in an EREV, application, such as the Chevy Volt®. In the Chevy Volt®, the battery system 100 provides the primary motive power for the vehicle. When the battery system is depleted, ICE 200 provides power to a generator to maintain charge to the drive system which continues to operate on electric power. In this manner, the Chevy Volt® operates in a manner similar to a diesel-electric locomotive, with the electric drive providing the primary source of motive power and the internal combustion engine providing power to run a generator to provide electric power to the primary battery energy storage system.

The Chevy Volt® comprises two electric motors 300 and 500, connected by a planetary gear. A 149 horsepower primary drive motor 500 is powered by the primary 16 kWh battery system. A secondary 74-horsepower motor/generator 300 is powered by a 1.4 liter internal combustion engine.

When the battery is charged, the battery 100 supplies electricity to the primary 149-horsepower motor 500 which, in turn, drives the vehicle. When the battery is depleted, the motor/generator is powered by the ICE 200 which spins the generator 300 to supply electricity to charge the battery pack 100. The ICE 200 does not directly supply motive power to the wheels 600.

An improved lead-acid battery component of the present invention may displace a portion of the 16 kWh Li-ion battery, as depicted in FIG. 3B, providing a number of advantages, including reduced footprint, volume, mass and cost and increased lifetime and safety.

TABLE 5
Plug-In Hybrid Electric Vehicle-EREV

| | | | | Rated | Rated |
|---|---|---|---|---|---|
| | Cost | Component | | Energy | Power |
| | per kWh | Cost | C-Rate | kWh | kW |
| Original Li- | $800/kWh | $12,800 | 9 C | 16 kWh | 136 kW |
| ion Battery | | | | | |
| Pack | | | | | |
| Modified Li- | $500/kWh | $4,500 | 2 C | 9 kWh | 16 kW |
| ion Battery | | | | | |
| Lead-Acid | $300/kWh | $1,050 | 35 C | 3.5 kWh | 120 kW |
| Battery | | | | | |
| Savings | | $7,250 | | 3.5 kWh | |
| | | Savings | | Reduction | |

### Example 3

### Extended Range Electric Vehicle (VIA®)

In another embodiment, a hybrid-battery system may displace a portion of the Li-ion battery system in a VIA®. In the VIA®, as depicted in FIG. 1, the battery system provides the primary motive power for the vehicle. When the battery system 100 is depleted, the ICE 200 provides power to a generator 300 to maintain charge to the drive system which continues to operate based on electric power. In this manner, the VIA® operates in a similar manner to a diesel-electric locomotive, with the electric drive providing the primary source of motive power and the internal combustion engine providing backup power to run a generator to provide electric power when the primary battery energy storage system has been depleted.

The VIA® comprises two electric motors. A 402-horsepower primary drive motor is powered by the primary 24 kWh battery system. A secondary 201-horsepower motor/generator is powered by a 4.3 liter internal combustion engine

When the battery 100 is charged, the battery 100 supplies electricity to the primary 402-horsepower motor 500 which, in turn, drives the vehicle. When the battery is depleted, the motor/generator 500 is powered by the ICE 200 which spins the generator 300 to supply electricity to charge the battery pack 100. The ICE 200 does not directly supply motive power to the wheels 600.

An improved lead-acid battery component of the present invention may displace a portion of the 24 kWh Li-ion battery, providing a number of advantages, including reduced footprint, volume, mass and cost and increased lifetime and safety.

TABLE 6
Plug-In Hybrid Electric Vehicle-EREV (VIA Motors)

| | | | | Rated | Rated |
|---|---|---|---|---|---|
| | Cost | Component | | Energy | Power |
| | per kWh | Cost | C-Rate | kWh | kW |
| Original Li- | $800/kWh | $19,200 | 9 C | 24 kWh | 216 kW |
| ion Battery | | | | | |
| Pack | | | | | |
| Modified Li- | $500/kWh | $6,750 | 2 C | 13.5 kWh | 27 kW |
| ion Battery | | | | | |
| Lead-Acid | $300/kWh | $1,650 | 35 C | 5.5 kWh | 193 kW |
| Battery | | | | | |
| Savings | | $10,800 | | 5 kWh | |
| | | Savings | | Reduction | |

### Example 4

### Extended Range Electric Vehicle (Fisker®)

In another embodiment, as depicted in FIG. 1, a hybrid-battery system may displace a portion of the Li-ion battery system in a Fisker® electric vehicle. In the Fisker®, the battery system provides the primary motive power for the vehicle. When the battery system is depleted, the ICE provides power to a generator to maintain charge to the drive system which continues to operate based on electric power. In this manner, the Fisker® operates in a similar manner to a diesel-electric locomotive, with the electric drive providing the primary source of motive power and the internal combustion engine providing backup power to run a generator to provide electric power when the primary battery energy storage system has been depleted

The Fisker® comprises three electric motors. Dual electric 201-horsepower (402 hp total) primary drive motors are powered by the primary 20 kWh battery system. A third 235-horsepower motor/generator is powered by a 2.0 liter internal combustion engine.

When the battery is charged, the battery supplies electricity to the Dual primary 201-horsepower motors which, in turn, drive the vehicle. When the battery is depleted, the motor/generator is powered by the ICE which spins the generator to supply electricity to charge the battery pack. The ICE does not directly supply motive power to the wheels.

An improved lead-acid battery component of the present invention may displace a portion of the 20 kWh Li-ion battery, providing a number of advantages, including reduced footprint, volume, mass and cost and increased lifetime and safety.

TABLE 7
Plug-In Hybrid Electric Vehicle-EREV (Fisker ® Karma)

| | | | | Rated | Rated |
|---|---|---|---|---|---|
| | Cost | Component | | Energy | Power |
| | per kWh | Cost | C-Rate | kWh | kW |
| Original Li- | $800/kWh | $16,000 | 9 C | 20 kWh | 180 kW |
| ion Battery | | | | | |
| Pack | | | | | |
| Modified Li- | $500/kWh | $5,750 | 2 C | 11.5 kWh | 23 kW |
| ion Battery | | | | | |
| Lead-Acid | $300/kWh | $1,350 | 35 C | 4.5 kWh | 158 kW |
| Battery | | | | | |
| Savings | | $8,900 | | 4 kWh | |
| | | Savings | | Reduction | |

### Example 5

### Hybrid City Bus (Mercedes-Benz Citaro Series Hybrid City Bus)

In a further embodiment, as depicted in FIG. 1, a hybrid battery system may displace a portion of the Li-ion battery system in a Mercedes-Benz Citaro series Hybrid City Bus. In the Mercedes-Benz, the battery system provides the primary motive power for the vehicle. When the battery system is depleted, the diesel engine provides power to a generator to maintain charge to the drive system which continues to operate based on electric power. In this manner, the Mercedes Benz operates in a similar manner to a diesel-electric locomotive, with the electric drive providing the primary source of motive power and the Diesel engine providing backup power to run a generator to provide electric power when the primary battery energy storage system has been depleted.

The Mercedes-Benz comprises four electric wheel hub motors. Each of the four wheel hub motors is a 107-horsepower primary drive motor that is powered by the primary 19.4 kWh battery system. The battery pack is charged by a 201-horsepower motor/generator powered by a 4.8 liter Diesel engine.

When the battery is charged, the battery supplies electricity to the four primary 107-horsepower motors which, in turn, drive the vehicle. When the battery is depleted, the motor/generator is powered by the ICE which spins the generator to supply electricity to charge the battery pack. The ICE does not directly supply motive power to the wheels.

An improved lead-acid battery component of the present invention may displace a portion of the 19.4 kWh Li-ion battery, providing a number of advantages, including reduced footprint, volume, mass and cost and increased lifetime and safety.

TABLE 8
The Mercedes-Benz Citaro Series Hybrid City Bus

| | | | | Rated | Rated |
|---|---|---|---|---|---|
| | Cost | Component | | Energy | Power |
| | per kWh | Cost | C-Rate | kWh | kW |
| Original Li- | $800/kWh | $15,520 | 9 C | 19.4 kWh | 180 kW |
| ion Battery | | | | | |
| Pack | | | | | |
| Modified Li- | $500/kWh | $5,500 | 2 C | 11 kWh | 22 kW |
| ion Battery | | | | | |
| Lead-Acid | $300/kWh | $1,350 | 35 C | 4.5 kWh | 158 kW |
| Battery | | | | | |
| Savings | | $8,670 | | 3.9 kWh | |
| | | Savings | | Reduction | |

The hybrid battery system of the present disclosure may be useful in any partially- or fully-electrified drive trains. Embodiments of the present disclosure may be useful in series, parallel, series/parallel, and/or dual-mode hybrid systems, as well as any systems involving electrification of the drive train. Thus, it is intended that all such variations be considered part of the invention, provided they come within the scope of the appended claims and their equivalents.

The electrochemical cells, batteries, and systems, as well as drive trains and vehicles comprising them, offer a number of advantages over prior know approaches. First, displacing high power demands on the Li-ion battery through a combination of a Li-ion battery component and a lead-acid battery component may reduce the overall size and weight of the battery system substantially. This is primarily a consequence of reducing the over-capacity needed in a purely Li-ion or Ni-MH battery electrochemisty. Rather than a 16 kWh Li-ion battery system, a 9 kWh Li-ion and 3.5 kWh lead-acid battery system may supply the power and energy requirements under the various duty conditions encountered by the vehicle, with no change in performance and at a substantially reduced size, weight, and/or volume and increased lifetime.

Second, by reducing the size of the Li-ion battery component, in particular, the energy storage system is made more simple and reliable. FIG. 6 depicts savings of 30% of the overall volume of the battery module by using an embodiment of the hybrid battery system of the present disclosure. Further, the C-rate may be reduced substantially, reducing the thermal and power management demands on a Li-ion battery component. The electrochemical cells, batteries, and power trains and vehicles made using them, offer an additional margin of safety and reduced toxicity is provided. The required collateral equipment may also be simplified, such as replacing passive cooling for more complex and expensive active cooling systems. The combination of the Li-ion battery pack and lead-acid battery pack may be operated at substantially lower temperatures, reducing hazards inherent to the Li-ion system.

Third, and perhaps most importantly, the cost of the system may be reduced substantially. As shown in the above Tables, the cost of the combination of a Li-ion battery component and a lead-acid battery component is substantially less than the cost of a single electrochemistry Li-ion battery system.

Other embodiments of the disclosure will be apparent to those skilled in the art from consideration of the specification and practice of the invention disclosed herein. For example, various elements or components of the disclosed embodiments may be combined with other elements or components of other embodiments, as appropriate for the desired application. Thus, it is intended that the specification and examples be considered as exemplary only, with a true scope and spirit of the disclosure being indicated by the following claims.

What is claimed is:

1. An electrochemical energy storage system for an application having design energy and power requirements, comprising:
first and second energy storage system components having different electro-chemistries and formed in different units;
said first energy storage system component including a non-lead-acid battery adapted to provide the energy requirements of the application;
said second energy storage system component including a lead-acid battery adapted to provide the power requirements of the application;
wherein said first and second energy storage system components have a combined capacity that is less than a capacity of a mono-electrochemical energy storage system adapted to supply both the power and energy requirements of the application;
wherein the lead-acid battery has a specific power that is greater than or equal to about 650 Watts/kilogram and less than or equal to about 1,900 Watts/kilogram; and
wherein the lead-acid battery has a specific energy that is greater than or equal to about 25 Watt-hours/kilogram and less than or equal to about 80 Watt-hours/kilogram.

2. The electrochemical energy storage system of claim 1, wherein the application is an electric vehicle.

3. The electrochemical energy storage system of claim 1, wherein said first energy storage system component is selected from a group comprising: a Li-ion battery, a Ni-MH battery, and a fuel cell.

4. The electrochemical energy storage system of claim 1, wherein said first energy storage component operates at a lower C-rate than said mono-electrochemical energy storage system adapted to provide both the energy and power requirements of the application.

5. The electrochemical energy storage system of claim 1, wherein said first energy storage component is adapted to operate at a lower temperature than mono-electrochemical said energy storage system adapted to provide both the design energy and power requirements of the application.

6. A battery system for an application having design energy and power requirements, comprising:
first and second energy storage system components having different electro chemistries and formed in different units;
said first energy storage system component including a non-lead-acid battery adapted to provide the energy requirements of the application;
said second energy storage system component including a lead-acid battery adapted to provide the power requirements of the application;
wherein said first and second energy storage system components have a combined capacity that is less than a capacity of a single chemistry energy storage system adapted to supply both the power and energy design requirements of the application;
wherein the lead-acid battery has a specific power that is greater than or equal to about 650 Watts/kilogram and less than or equal to about 1,900 Watts/kilogram; and
wherein the lead-acid battery has a specific energy that is greater than or equal to about 25 Watt-hours/kilogram and less than or equal to about 80 Watt-hours/kilogram.

7. The battery system of claim 6, wherein the application is an electric vehicle.

8. The battery system of claim 6, wherein said first energy storage system component is selected from a group comprising: a Li-ion battery, a Ni-MH battery, and a fuel cell.

9. The battery system of claim 6, wherein said first energy storage component operates at a lower C-rate than said single chemistry energy storage system adapted to provide both the design energy and power requirements of the application.

10. The battery system of claim 6, wherein said first energy storage component operates at a lower temperature than said single chemistry energy storage system adapted to provide both the design energy and power requirements of the application.

11. A vehicle having design energy and power requirements, comprising:
a motor for driving the vehicle according to the energy and power requirements; and
first and second energy storage system components electrically coupled to the motor, the first and second energy storage system components including different electro chemistries and being formed in different units;
said first energy storage system component including a non-lead-acid battery adapted to provide the energy requirements of the vehicle;
said second energy storage system component including a lead-acid battery adapted to provide the power requirements of the vehicle;
wherein said first and second energy storage system components have a combined capacity that is less than a capacity of a mono-electrochemistry battery pack adapted to supply both the power and energy requirements of the vehicle;
wherein the lead-acid battery has a specific power that is greater than or equal to about 650 Watts/kilogram and less than or equal to about 1,900 Watts/kilogram; and
wherein the lead-acid battery has a specific energy that is greater than or equal to about 25 Watt-hours/kilogram and less than or equal to about 80 Watt-hours/kilogram.

12. The vehicle of claim 11, wherein the vehicle comprises a hybrid electric-drive vehicle.

13. The vehicle of claim 11, wherein said first energy storage system component further comprises a Li-ion battery.

14. The vehicle of claim 11, wherein said first energy storage component operates at a lower C-rate than said single chemistry energy storage system adapted to provide both the design energy and power requirements of the application.

15. The vehicle of claim 11, wherein said first energy storage component operates at a lower temperature than said single chemistry energy storage system adapted to provide both the design energy and power requirements of the application.
